(19) United States
(12) Patent Application Publication
(10) Pub. No.: US 2013/0118771 A1
(43) Pub. Date: May 16, 2013

(54) Electrical Outlet Cover

(71) Applicant: Eric Tonnesen, New Hampton, NY (US)

(72) Inventor: Eric Tonnesen, New Hampton, NY (US)

(21) Appl. No.: 13/677,260

(22) Filed: Nov. 14, 2012

Related U.S. Application Data
(60) Provisional application No. 61/629,106, filed on Nov. 14, 2011.

(51) Int. Cl. H02G 3/14

(52) U.S. Cl. CPC H02G 3/14
USPC 174/66

(57) ABSTRACT

An electrical outlet cover for mounting to an electrical outlet having a pair of electrical sockets, comprising: a faceplate having a pair of electrical socket covers adapted to be aligned with the pair of electrical sockets, each electrical socket cover having electrical socket cover slotted holes and an electrical socket cover ground hole for receiving prongs of an electrical plug therethrough and insertion into each of the electrical sockets; the faceplate having a rear having a frame adapted to fit about the pair of electrical sockets and align the electrical socket cover slotted holes and the electrical socket cover ground hole with electrical socket slotted holes and electrical socket ground holes of the electrical outlet, respectively; the rear of the faceplate further comprising a mounting block between the pair of electrical sockets of the electrical outlet, having a hole therethrough for fastening the electrical outlet cover to the electrical outlet.

This application claims the benefit of U.S. Provisional Application No. 61/629,106, filed Nov. 14, 2011, the full disclosure of which is incorporated herein by reference.

### BACKGROUND OF THE INVENTION

1. Field of the Invention

The present invention relates generally to electrical outlet covers, faceplates, and wall plates and more particularly to electrical outlet covers for mounting to electrical outlets, covering the electrical outlets, inserting prongs of electrical plugs therethrough, and allowing full functionality of the electrical outlets.

2. Background Art

During various phases of home and building renovation, remodeling, rehabilitation and construction, it is often discovered that existing electrical outlets do not meet the needs of home buyers, designers, real estate developers, real estate sales people, and/or commercial property purchasers, often based upon the appearance of the existing electrical outlets.

Because of the expense of replacing a large number of electrical outlets in remodeling a home or building or renovation of the home or building, these electrical outlets are often left in place, in order to keep costs down.

In those instance where appearance of the existing electrical outlets is the primary reason for replacing the electrical outlets, an alternative, more cost effective, and less time consuming approach, which allows changing the appearance of existing outlets and providing full functionality of the existing outlets, while not actually changing the electrical outlets, is needed.

The desire to change color schemes, and/or the desire to change the appearance of electrical outlets from, for example, standard duplex receptacles to contemporary duplex receptacles or vice versa, also contribute to the need for electrical outlet covers that may be used to change the appearance of electrical outlets, while allowing full functionality of the electrical outlets and not actually changing the electrical outlets.

An electrical outlet cover for mounting to an electrical outlet having a pair of electrical sockets is needed that comprises: a faceplate having a pair of electrical socket covers adapted to be aligned with the pair of electrical sockets, each electrical socket cover having electrical socket cover slotted holes and an electrical socket cover ground hole for receiving prongs of an electrical plug therethrough and insertion into each of the electrical sockets; the faceplate having a rear having a frame adapted to fit about the pair of electrical sockets and align the electrical socket cover slotted holes and the electrical socket cover ground hole with electrical socket slotted holes and electrical socket ground holes of the electrical outlet, respectively; the rear of the faceplate further comprising a mounting block between the pair of electrical sockets of the electrical outlet, having a hole therethrough for fastening the electrical outlet cover to the electrical outlet.

For the foregoing reasons, there is a need for an electrical outlet cover that is durable, light weight, inexpensive, safe to use, attractive, sturdy, of simple construction, and easy to manufacture. The electrical outlet cover should be capable of covering unsightly electrical outlets and/or changing the style and/or appearance of an existing electrical outlet by covering the electrical outlet with a more attractive electrical outlet cover, while allowing full functionality of an electrical outlet that the electric outlet cover is mounted to.

### SUMMARY

The present invention is directed to an electrical outlet cover for mounting to an electrical outlet, the electrical outlet having a pair of electrical sockets, each electrical socket of the pair of electrical sockets having electrical socket slotted holes and an electrical socket ground hole for receiving prongs of an electrical plug, the electrical outlet having a threaded hole between the electrical sockets for receiving a threaded fastener, comprising: a faceplate comprising a pair of electrical socket covers adapted to be aligned with the pair of electrical sockets, each electrical socket cover of the pair of electrical socket covers having electrical socket cover slotted holes and an electrical socket cover ground hole for receiving prongs of the electrical plug therethrough and insertion of the prongs into the electrical socket slotted holes and the electrical socket ground hole, respectively; the faceplate having a rear having a frame adapted to fit about the pair of electrical sockets of the electrical outlet and align the electrical socket cover slotted holes and the electrical socket cover ground hole with the electrical socket slotted holes and the electrical socket ground hole, respectively; the rear of the faceplate further comprising a mounting block adapted to fit between the pair of electrical sockets of the electrical outlet, the mounting block having an electrical outlet cover hole therethrough, the mounting block adapted to align the electrical outlet cover hole with the threaded hole of the electrical outlet and receive a portion of the threaded fastener therethrough for fastening the electrical outlet cover to the electrical outlet.

The mounting block at the rear of the faceplate, which is adapted to fit between the pair of electrical sockets of the electrical outlet, is also further adapted to align the electrical socket cover slotted holes and the electrical socket cover ground holes with the electrical socket slotted holes and the electrical socket ground holes, respectively.

The faceplate of the electrical outlet cover typically has a substantially planar face having arcuate edges.

The electrical outlet cover of the present invention is durable, light weight, inexpensive, safe to use, attractive, sturdy, of simple construction, easy to manufacture, and allows full functionality of an electrical outlet that the electric outlet cover is mounted to.

In another embodiment of the present invention, an electrical outlet cover for mounting to an electrical outlet, the electrical outlet having a pair of electrical sockets, each electrical socket of the pair of electrical sockets having electrical socket slotted holes and an electrical socket ground hole for receiving prongs of an electrical plug, the electrical outlet having opposing tabs having opposing threaded holes for receiving opposing threaded fasteners, comprising: a faceplate comprising a pair of electrical socket covers adapted to be aligned with the pair of electrical sockets, each electrical socket cover of the pair of electrical socket covers having electrical socket cover slotted holes and an electrical socket cover ground hole for receiving prongs of the electrical plug therethrough and insertion of the prongs into the electrical socket slotted holes and the electrical socket ground hole, respectively; the faceplate having a rear having a frame adapted to fit about the pair of electrical sockets of the electrical outlet and align the electrical socket cover slotted holes and the electrical socket cover ground hole with the electrical socket slotted holes and the electrical socket ground hole, respectively; the rear of the faceplate further comprising opposing mounting blocks adapted to abut the opposing tabs of the electrical outlets, the opposing mounting blocks having opposing electrical outlet cover holes therethrough, the opposing electrical outlet cover holes adapted to be aligned with the opposing threaded holes of the opposing tabs of the electrical outlet and receive portions of the threaded fasteners therethrough for fastening the electrical outlet cover to the electrical outlet.

The electrical outlet cover is typically of one piece molded construction and preferably of thermoplastic, thermosetting polymers, thermoplastic polymers, such as polycarbonates, or other suitable material or combination thereof. The polycarbonates may be used to facilitate the electrical outlet cover to glow in the dark.

The face of the electrical outlet cover may optionally be of one or more colors and/or may optionally have a decorative design.

The electrical outlet cover may be used with a variety of electrical outlets, such as, for example, standard 115 volt, 15 amp duplex receptacles or alternatively contemporary 115 volt, 15 amp duplex receptacles, although electrical outlets having other suitable configurations and ratings may be used.

### DRAWINGS

These and other features, aspects, and advantages of the present invention will become better understood with regard to the following description, appended claims, and accompanying drawings where:

FIG. 1 is a front perspective view of an electrical outlet cover, constructed in accordance with the present invention;

FIG. 2 is a rear perspective view of the electrical outlet cover of FIG. 1;

FIG. 3 is an exploded view showing the electrical outlet cover of FIG. 1 and an electrical outlet, the exploded view showing the electrical outlet cover of FIG. 1 for mounting to the electrical outlet;

FIG. 4 is a front view of the electrical outlet cover of FIG. 1;

FIG. 5 is a rear view of the electrical outlet cover of FIG. 1;

FIG. 6 is a side view of the electrical outlet cover of FIG. 1;

FIG. 7 is a top view of the electrical outlet cover of FIG. 1;

FIG. 8 is a cross section view of the electrical outlet cover of FIG. 1;

FIG. 9 is a front perspective view of an alternate embodiment of an electrical outlet cover, constructed in accordance with the present invention;

FIG. 10 is a rear perspective view of the alternate embodiment of the electrical outlet cover of FIG. 9;

FIG. 11 is an exploded view showing the alternate embodiment of the electrical outlet cover of FIG. 9 and an alternate electrical outlet, the exploded view showing the electrical outlet cover of FIG. 9 for mounting to the alternate electrical outlet;

FIG. 12 is a front view of the alternate embodiment of the electrical outlet cover of FIG. 9;

FIG. 13 is a rear view of the alternate embodiment of the electrical outlet cover of FIG. 9;

FIG. 14 is a side view of the alternate embodiment of the electrical outlet cover of FIG. 9;

FIG. 15 is a top view of the alternate embodiment of the electrical outlet cover of FIG. 9;

FIG. 16 is a cross section view of the alternate embodiment of the electrical outlet cover of FIG. 9.

FIG. 17 is a front perspective view of another alternate embodiment of an electrical outlet cover, constructed in accordance with the present invention;

FIG. 18 is a rear perspective view of the other alternate embodiment of the electrical outlet cover of FIG. 17;

FIG. 19 is an exploded view showing the electrical outlet cover of FIG. 17 and the alternate electrical outlet of FIG. 11, the exploded view showing the electrical outlet cover of FIG. 17 for mounting to the alternate electrical outlet of FIG. 11;

FIG. 20 is a front view of the other alternate embodiment of the electrical outlet cover of FIG. 17;

FIG. 21 is a rear view of the other alternate embodiment of the electrical outlet cover of FIG. 17;

FIG. 22 is a side view of the other alternate embodiment of the electrical outlet cover of FIG. 17;

FIG. 23 is a top view of the other alternate embodiment of the electrical outlet cover of FIG. 17;

FIG. 24 is a cross section view of the other alternate embodiment of the electrical outlet cover of FIG. 17;

FIG. 25 is a front perspective view of another alternate embodiment of an electrical outlet cover, constructed in accordance with the present invention;

FIG. 26 is a rear perspective view of the other alternate embodiment of the electrical outlet cover of FIG. 25;

FIG. 27 is an exploded view showing the electrical outlet cover of FIG. 25 and the electrical outlet of FIG. 3, the exploded view showing the electrical outlet cover of FIG. 25 for mounting to the electrical outlet of FIG. 3;

FIG. 28 is a front view of the other alternate embodiment of the electrical outlet cover of FIG. 25;

FIG. 29 is a rear view of the other alternate embodiment of the electrical outlet cover of FIG. 25;

FIG. 30 is a side view of the other alternate embodiment of the electrical outlet cover of FIG. 25;

FIG. 31 is a top view of the other alternate embodiment of the electrical outlet cover of FIG. 25; and

FIG. 32 is a cross section view of the other alternate embodiment of the electrical outlet cover of FIG. 25.

### DESCRIPTION

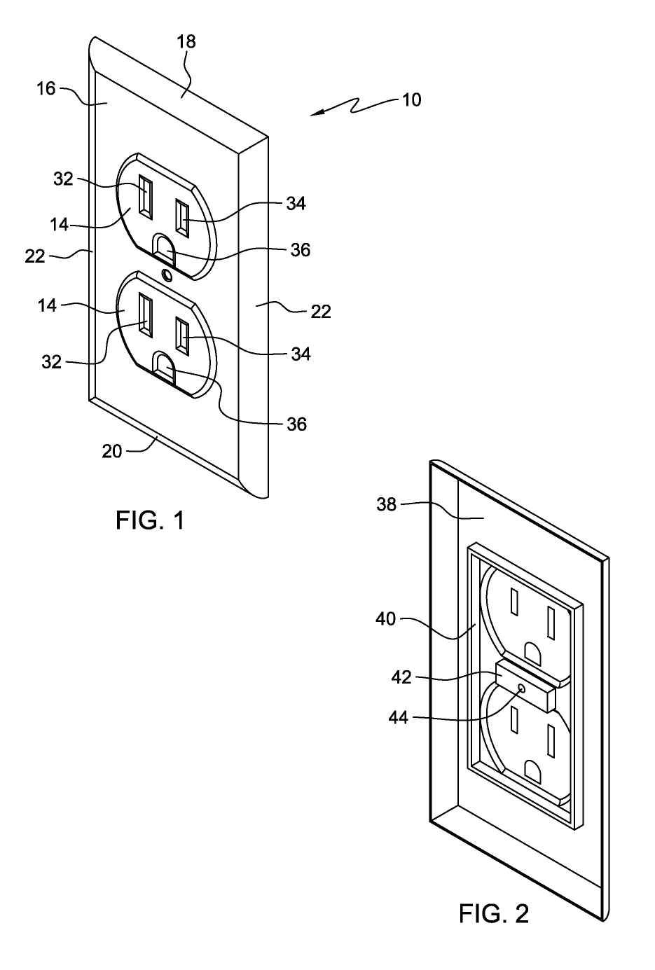

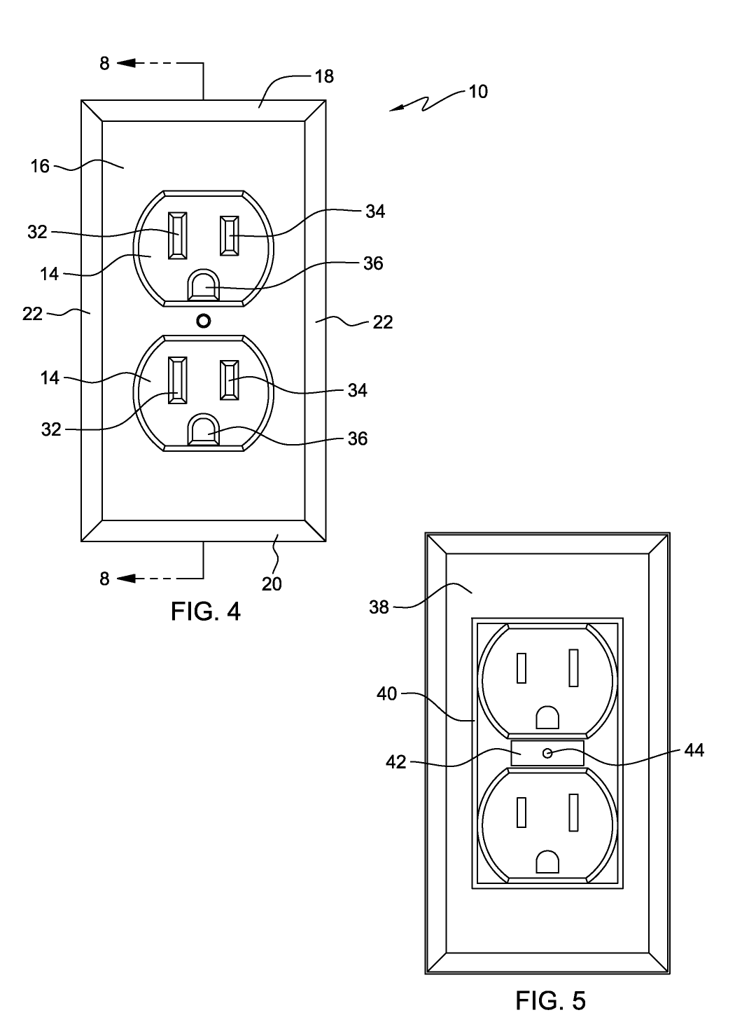

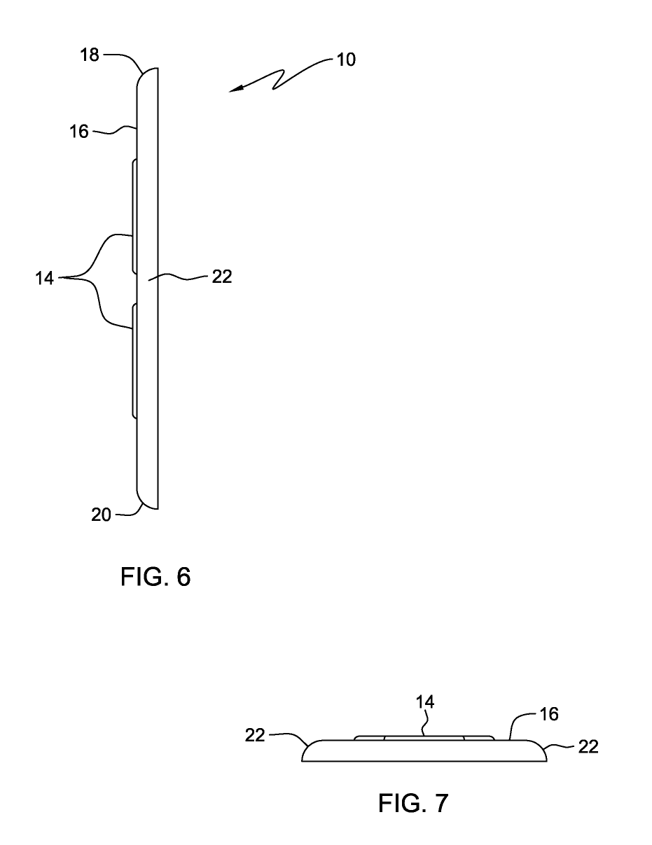

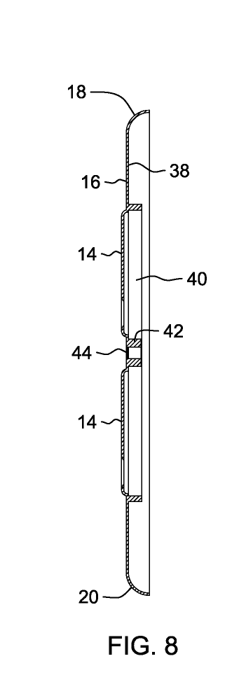

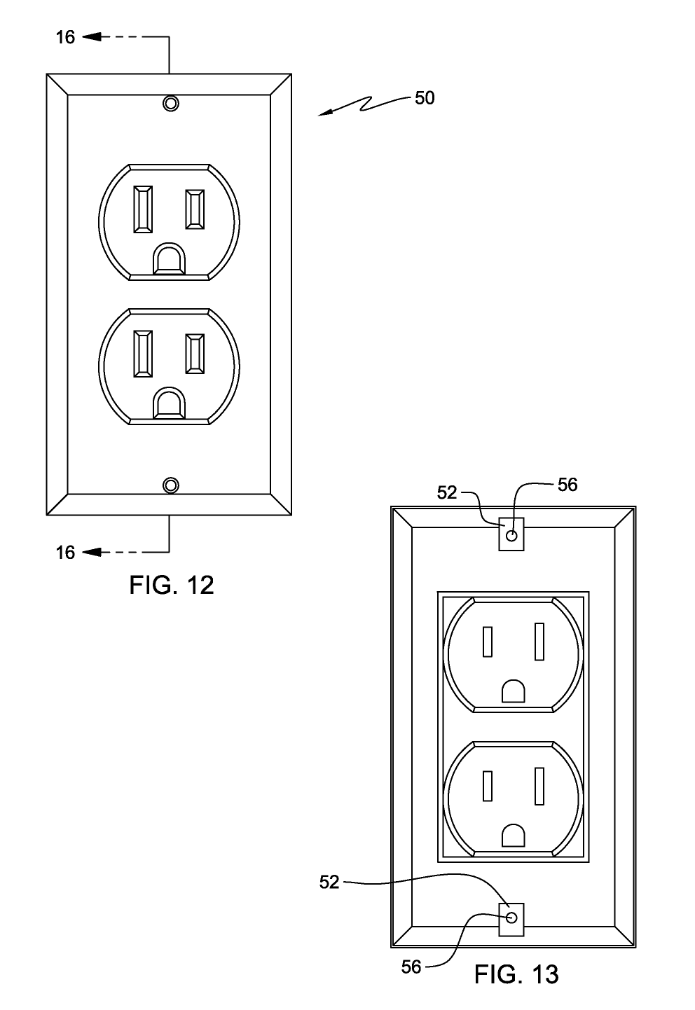

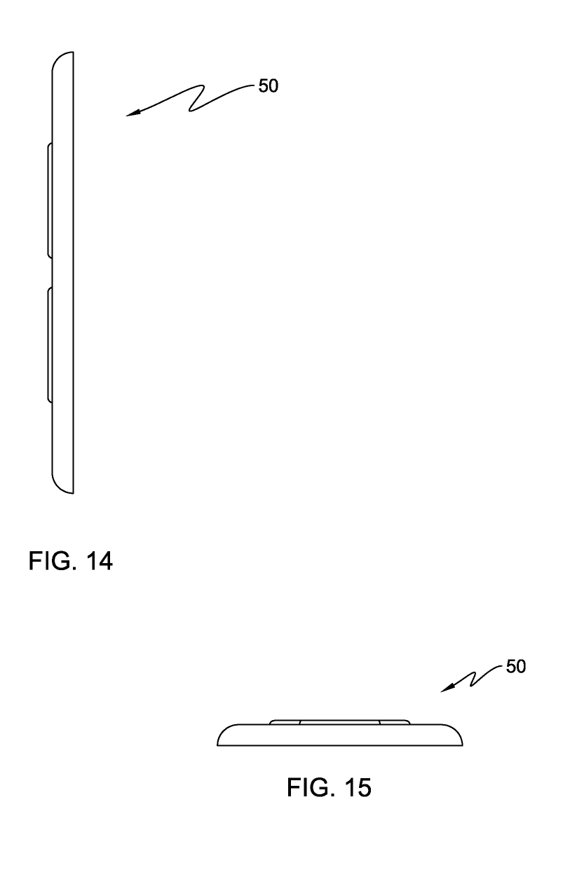

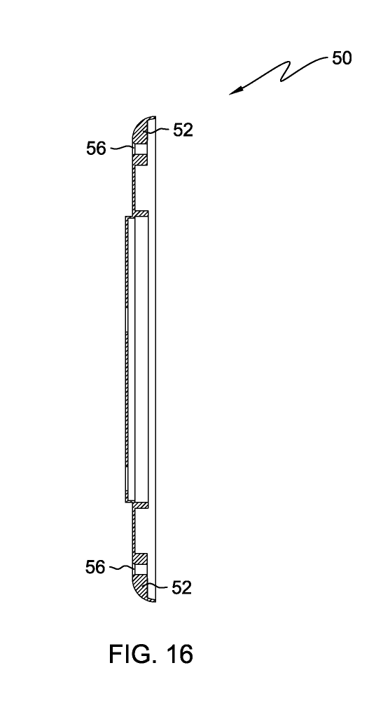

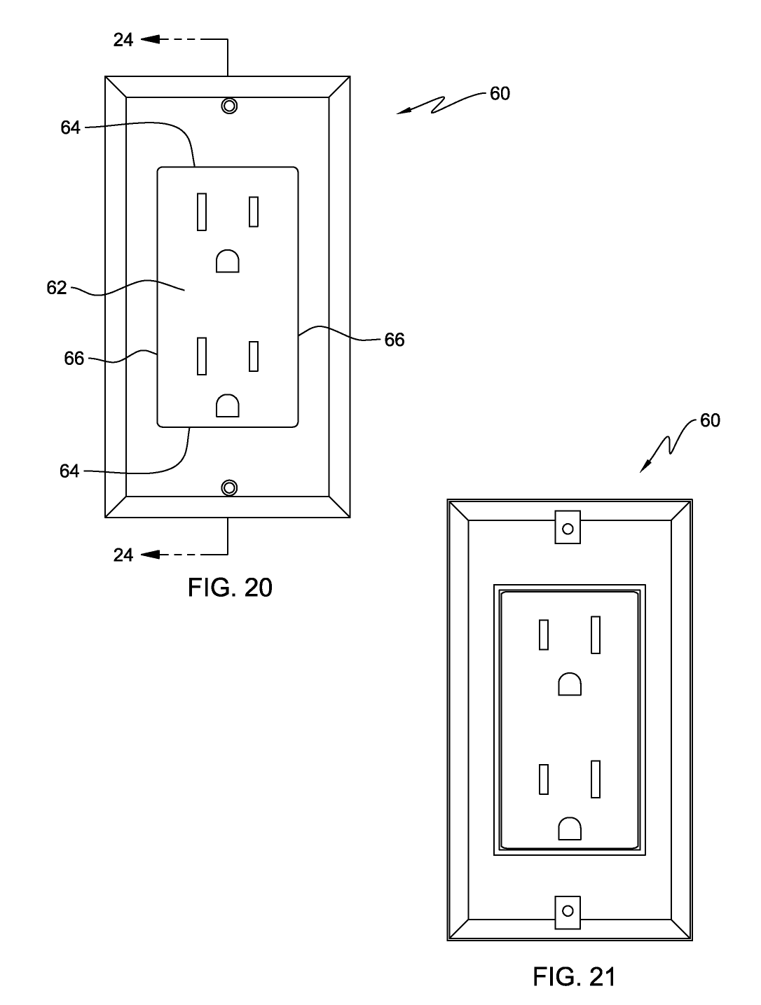

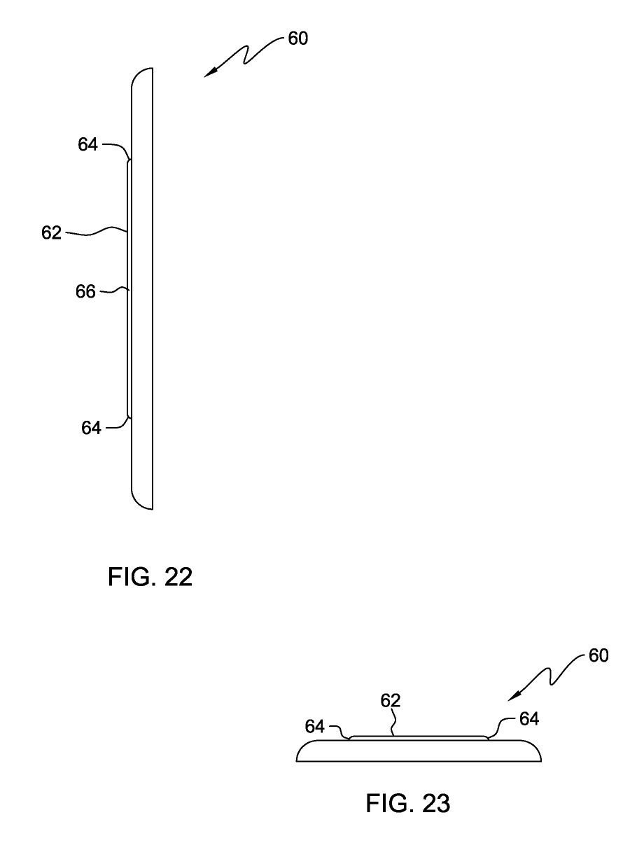

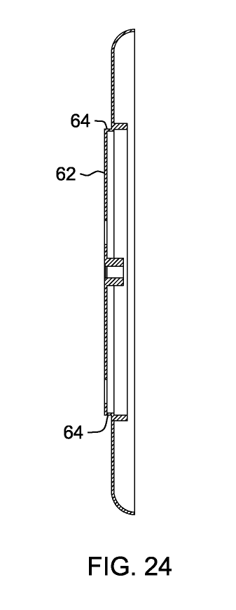

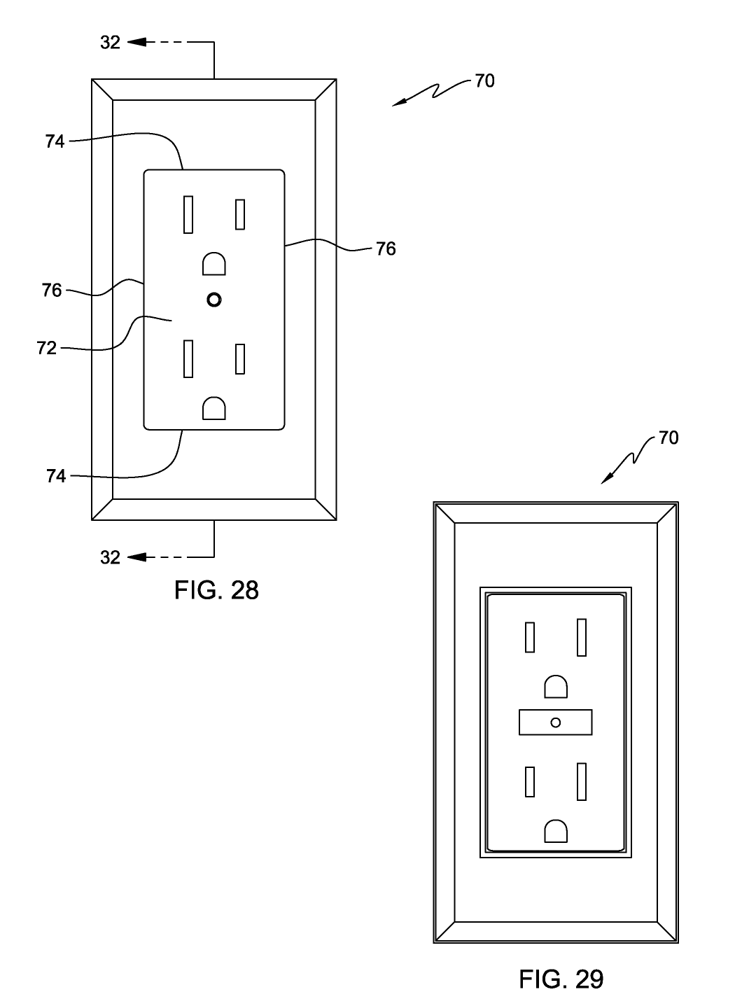

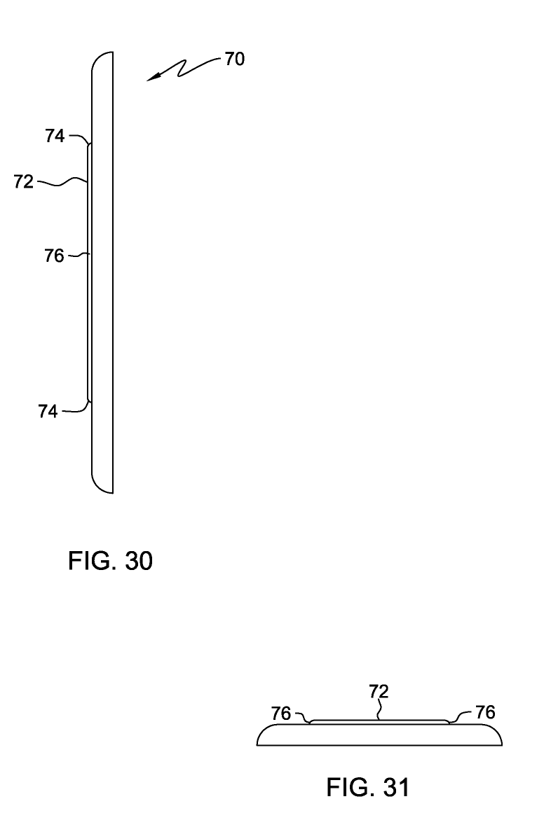

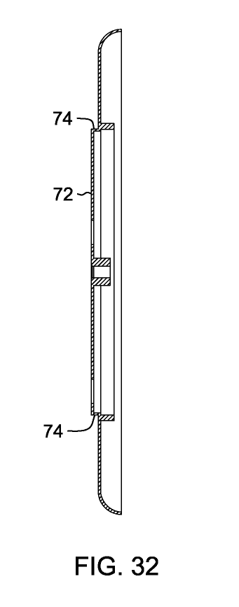

The preferred embodiments of the present invention will be described with reference to FIGS. 1-32 of the drawings. Identical elements in the various figures are identified with the same reference numbers.

FIGS. 1-8 show an embodiment of the present invention, an electrical outlet cover 10 for mounting to an electrical outlet 12. The electrical outlet cover 10 has electrical socket covers 14, face 16, arcuate top and bottom edges 18 and 20, respectively, and arcuate side edges 22. The electrical outlet 12 has electrical sockets 24, each of which have slotted holes 26 and 28 and ground holes 30 for receiving prongs of electrical plugs that may be plugged into the electrical outlet 12.

The electrical socket covers 14 have electrical outlet cover slotted holes 32 and 34 and electrical outlet cover ground holes 36 that align with the slotted holes 26 and 28 and the ground holes 30 of the electrical sockets 24, respectively, and facilitate insertion of the prongs of the plugs therethrough.

The electrical outlet cover 10 has back 38 having a substantially centrally disposed frame 40 that facilitates alignment of the electrical outlet cover 10 about the electrical sockets 24 of the electrical outlet 12, the frame 40 making a snug fit about the electrical outlet sockets 24.

The back 38 of the electrical outlet cover 10 also has substantially centrally disposed mounting block 42 that also facilitates alignment of the electrical outlet cover 10 with the electrical outlet 12, the mounting block 42 making a snug fit between the electrical outlet sockets 24, and further facilitating alignment of the electrical outlet cover slotted holes 32 and 34 and the electrical outlet cover ground holes 36 with the slotted holes 26 and 28 and the ground holes 30 of the electrical sockets 24, respectively.

The mounting block 42 has a substantially centrally disposed countersunk hole 44 therethrough that fastener 46 may be used to fasten the electrical outlet cover 10 to the electrical outlet 12.

The electrical outlet 12 is shown mounted to an electrical box 48.

The electrical outlet cover 10 is typically of one piece molded construction and preferably of thermoplastic, thermosetting polymers, thermoplastic polymers, such as polycarbonates, or other suitable material or combination thereof. The polycarbonates may be used to facilitate the electrical outlet cover 10 to glow in the dark.

The face 16 of the electrical outlet cover 10 is preferably substantially planar and may optionally have a decorative design. The face 16 of the electrical outlet cover 10 may optionally be of one or more colors.

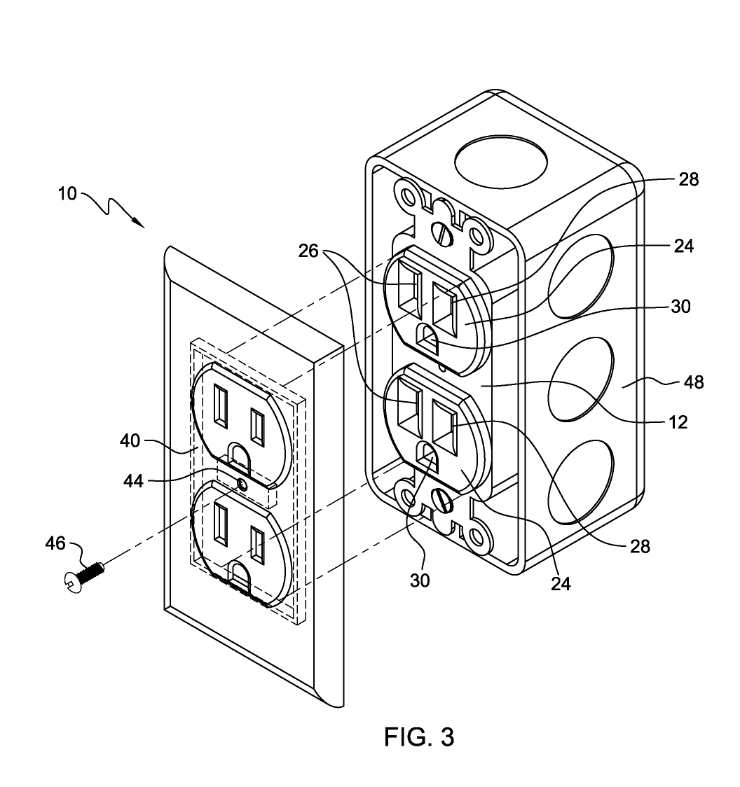

The electrical outlet 12 shown in FIG. 3 is typically a standard 115 volt, 15 amp duplex receptacle, although other suitable configurations and ratings may be used.

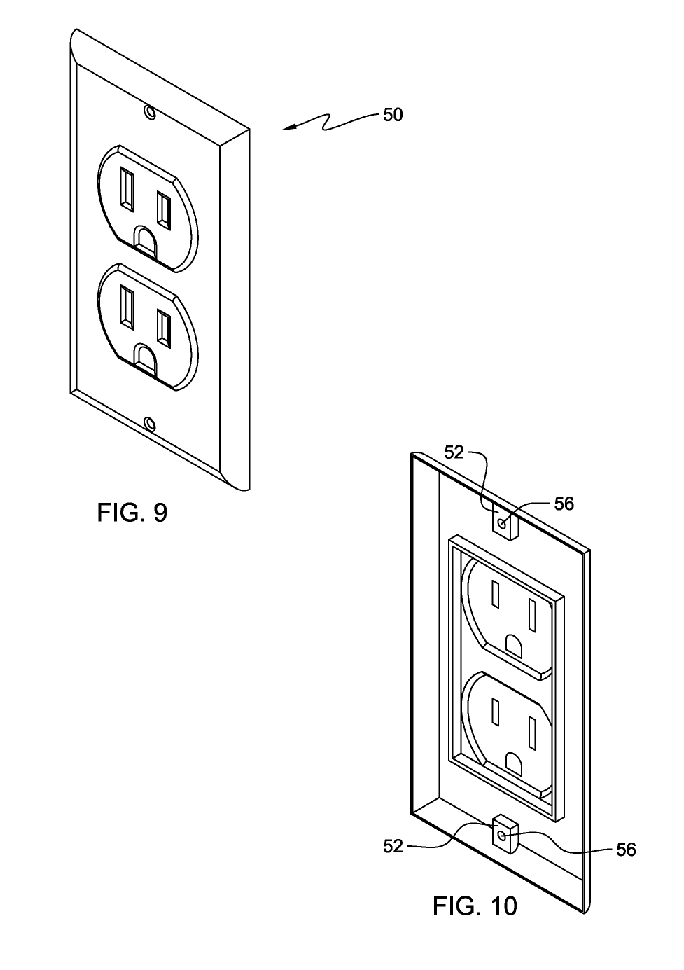

FIGS. 9-16 show an alternate embodiment of an electrical outlet cover 50, which is substantially the same as the electrical outlet cover 10, except that the electrical outlet cover 50 has mounting blocks 52 that may be used to mount the electrical outlet cover 50 to an alternate electrical outlet 54. Each of the mounting blocks 52 has a countersunk hole 56 therethrough that fasteners 58 may be used to fasten the electrical outlet cover 50 to the electrical outlet 54.

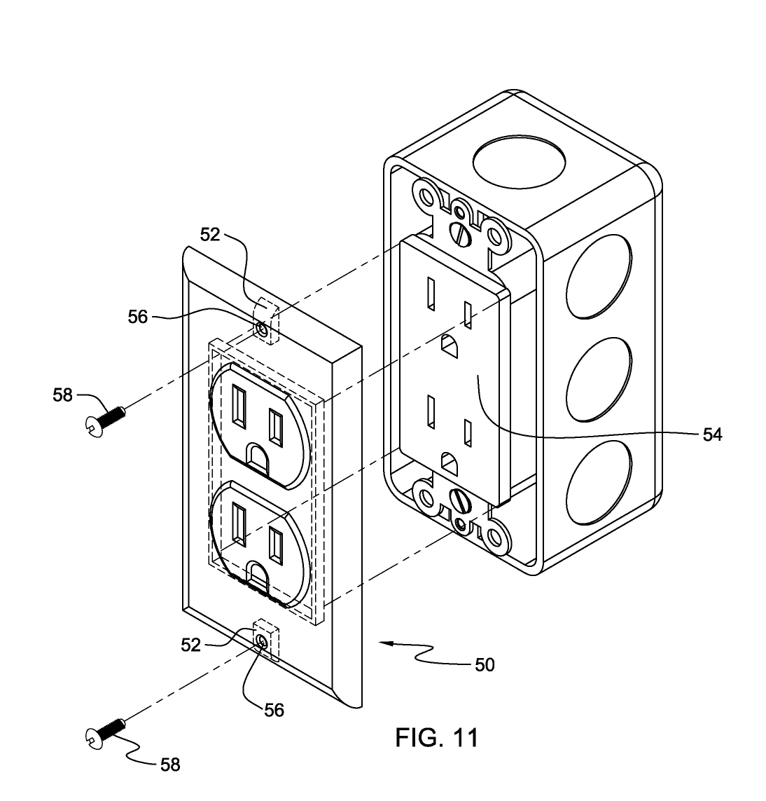

The electrical outlet 54 shown in FIG. 11 is typically a contemporary 115 volt, 15 amp duplex receptacle, although other suitable configurations and ratings may be used.

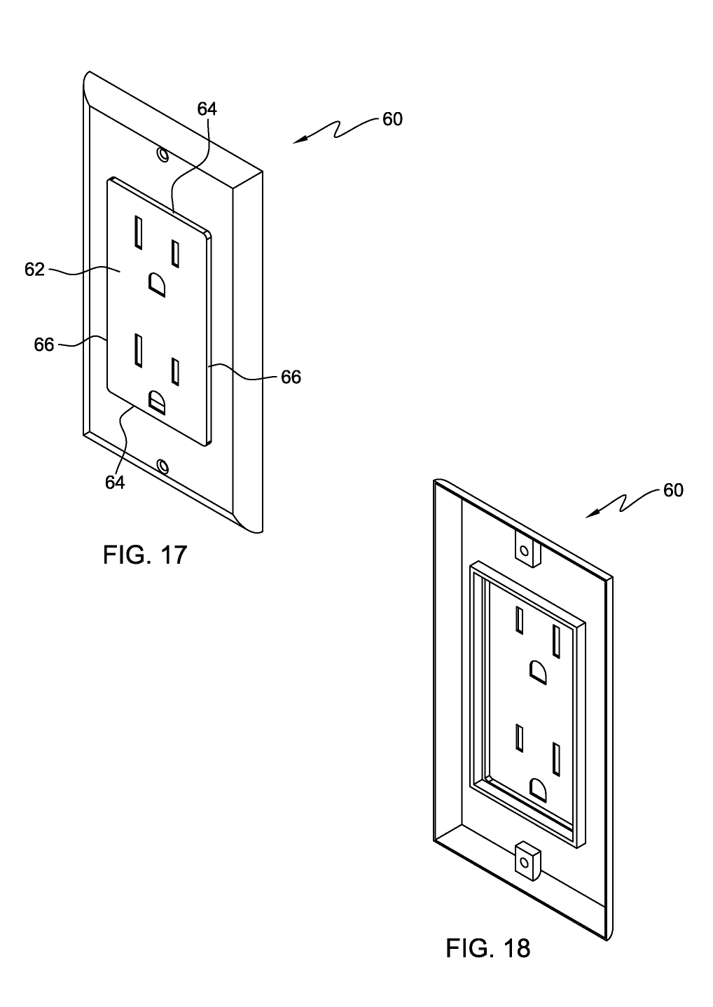

FIGS. 17-24 show an alternate embodiment of an electrical outlet cover 60, which is substantially the same as the electrical outlet cover 50, except that the electrical outlet cover 60 has a substantially planar contiguous electrical socket cover 62 bordered by raised edges 64 and 66.

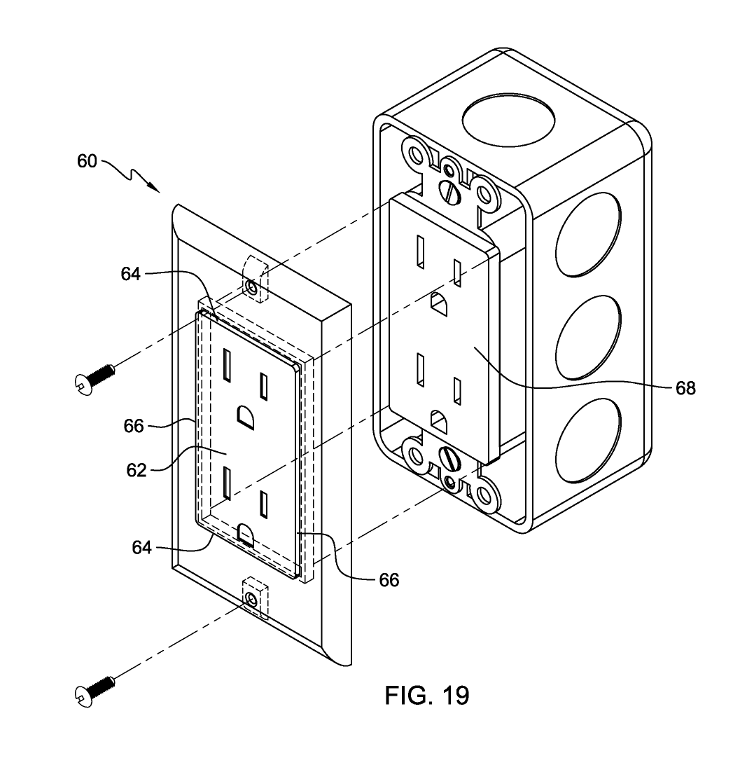

Electrical outlet 68 shown in FIGS. 19, which is substantially the same electrical outlet shown in FIG. 11, is typically a contemporary 115 volt, 15 amp duplex receptacle, although other suitable configurations and ratings may be used.

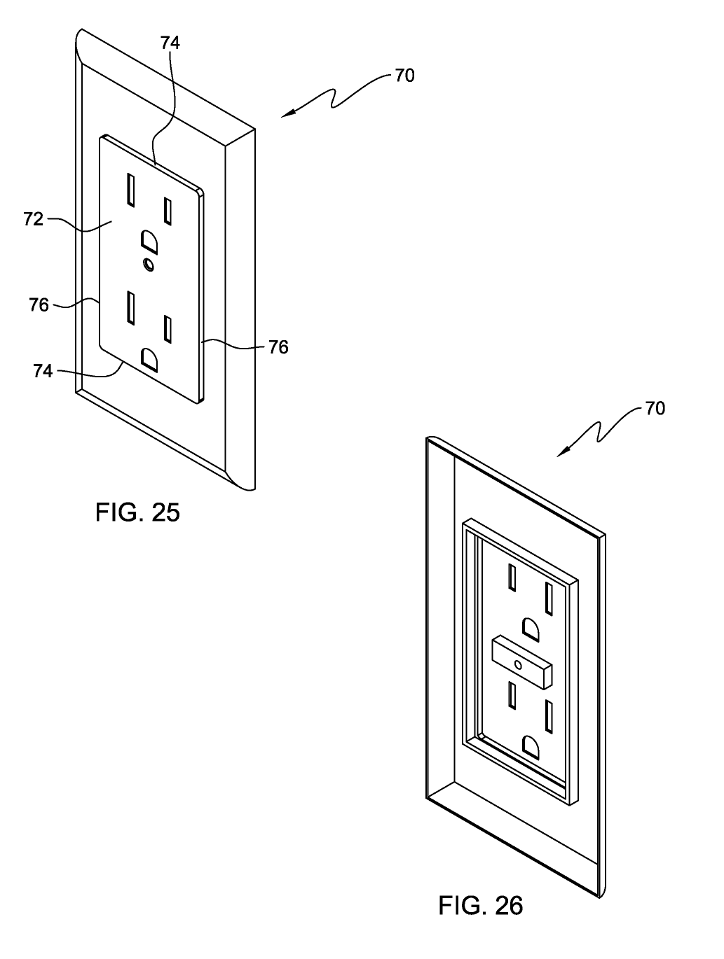

FIGS. 25-32 show an alternate embodiment of an electrical outlet cover 70, which is substantially the same as the electrical outlet cover 10, except that the electrical outlet cover 70 has a substantially planar contiguous electrical socket cover 72 bordered by raised edges 74 and 76.

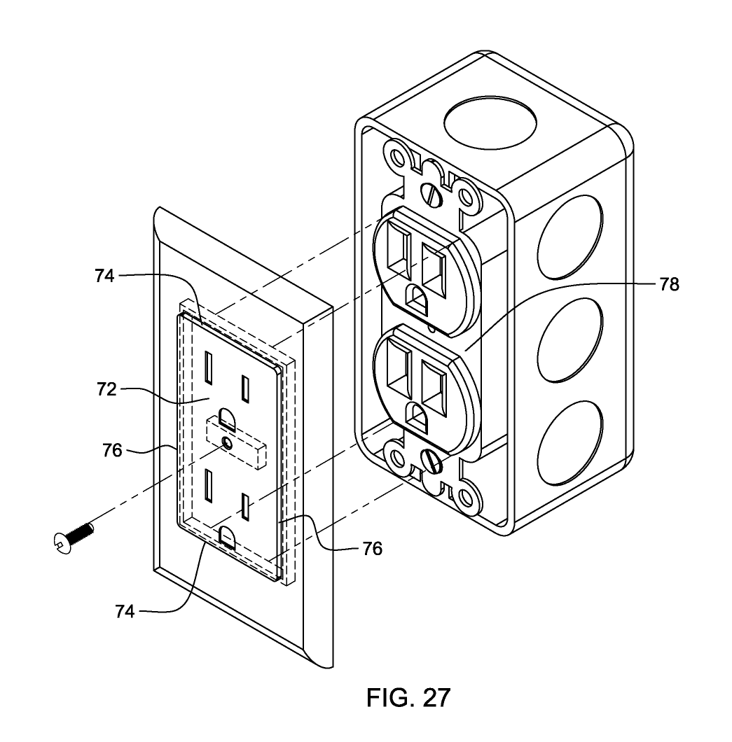

Electrical outlet 78 shown in FIG. 27, which is substantially the same electrical outlet shown in FIG. 3, is typically a standard 115 volt, 15 amp duplex receptacle, although other suitable configurations and ratings may be used.

Although the present invention has been described in considerable detail with reference to certain preferred versions thereof, other versions are possible. Therefore, the spirit and scope of the appended claims should not be limited to the description of the preferred versions contained herein.

What is claimed is:

1. An electrical outlet cover for mounting to an electrical outlet, the electrical outlet having a pair of electrical sockets, each electrical socket of the pair of electrical sockets having electrical socket slotted holes and an electrical socket ground hole for receiving prongs of an electrical plug, the electrical outlet having a threaded hole between the electrical sockets for receiving a threaded fastener, comprising:
a faceplate comprising a pair of electrical socket covers adapted to be aligned with said pair of electrical sockets,
each electrical socket cover of said pair of electrical socket covers having electrical socket cover slotted holes and an electrical socket cover ground hole for receiving prongs of said electrical plug therethrough and insertion of said prongs into said electrical socket slotted holes and said electrical socket ground hole, respectively;
said faceplate having a rear having a frame adapted to fit about said pair of electrical sockets of said electrical outlet and align said electrical socket cover slotted holes and said electrical socket cover ground hole with said electrical socket slotted holes and said electrical socket ground hole, respectively;
said rear of said faceplate further comprising a mounting block adapted to fit between said pair of electrical sockets of said electrical outlet and align said electrical socket cover slotted holes and said electrical socket cover ground hole with said electrical socket slotted holes and said electrical socket ground hole, respectively,
said mounting block having an electrical outlet cover hole therethrough, said mounting block adapted to align said electrical outlet cover hole with said threaded hole of said electrical outlet and receive a portion of said threaded fastener therethrough for fastening said electrical outlet cover to said electrical outlet.

2. The electrical outlet cover according to claim 1, wherein:
said faceplate has a substantially planar face having arcuate edges.

3. An electrical outlet cover for mounting to an electrical outlet, the electrical outlet having a pair of electrical sockets, each electrical socket of the pair of electrical sockets having electrical socket slotted holes and an electrical socket ground hole for receiving prongs of an electrical plug, the electrical outlet having a threaded hole between the electrical sockets for receiving a threaded fastener, comprising:
a faceplate comprising a pair of electrical socket covers adapted to be aligned with said pair of electrical sockets,
each electrical socket cover of said pair of electrical socket covers having electrical socket cover slotted holes and an electrical socket cover ground hole for receiving prongs of said electrical plug therethrough and insertion of said prongs into said electrical socket slotted holes and said electrical socket ground hole, respectively;
said faceplate having a rear having a frame adapted to fit about said pair of electrical sockets of said electrical outlet and align said electrical socket cover slotted holes and said electrical socket cover ground hole with said electrical socket slotted holes and said electrical socket ground hole, respectively;
said rear of said faceplate further comprising a mounting block adapted to fit between said pair of electrical sockets of said electrical outlet,
said mounting block having an electrical outlet cover hole therethrough,
said mounting block adapted to align said electrical outlet cover hole with said threaded hole of said electrical outlet and receive a portion of said threaded fastener therethrough for fastening said electrical outlet cover to said electrical outlet.

4. The electrical outlet cover according to claim 3, wherein:
said faceplate has a substantially planar face having arcuate edges.

5. An electrical outlet cover for mounting to an electrical outlet, the electrical outlet having a pair of electrical sockets, each electrical socket of the pair of electrical sockets having electrical socket slotted holes and an electrical socket ground hole for receiving prongs of an electrical plug, the electrical outlet having opposing tabs having opposing threaded holes for receiving opposing threaded fasteners, comprising:
a faceplate comprising a pair of electrical socket covers adapted to be aligned with said pair of electrical sockets,
each electrical socket cover of said pair of electrical socket covers having electrical socket cover slotted holes and an electrical socket cover ground hole for receiving prongs of said electrical plug therethrough and insertion of said prongs into said electrical socket slotted holes and said electrical socket ground hole, respectively;
said faceplate having a rear having a frame adapted to fit about said pair of electrical sockets of said electrical outlet and align said electrical socket cover slotted holes and said electrical socket cover ground hole with said electrical socket slotted holes and said electrical socket ground hole, respectively;
said rear of said faceplate further comprising opposing mounting blocks adapted to abut said opposing tabs of said electrical outlets,
said opposing mounting blocks having opposing electrical outlet cover holes therethrough,
said opposing electrical outlet cover holes adapted to be aligned with said opposing threaded holes of said opposing tabs of said electrical outlet and receive portions of said threaded fasteners therethrough for fastening said electrical outlet cover to said electrical outlet.

6. The electrical outlet cover according to claim 5, wherein:
said faceplate has a substantially planar face having arcuate edges.
